(19) United States
(12) Patent Application Publication
(10) Pub. No.: US 2015/0191121 A1
(43) Pub. Date: Jul. 9, 2015

(54) DISPLAY CONTROL METHOD FOR INVERTED VEHICLE

(71) Applicant: TOYOTA JIDOSHA KABUSHIKI KAISHA, Toyota-shi (JP)

(72) Inventors: Yusuke KIDA, Toyota-shi (JP); Norimasa KOBORI, Nagoya-shi (JP)

(21) Appl. No.: 14/558,350

(22) Filed: Dec. 2, 2014

(30) Foreign Application Priority Data
Jan. 9, 2014 (JP) 2014-002227

(51) Int. Cl. B60R 1/00

(52) U.S. Cl. CPC B60R 1/00; B60R 2300/8086; B60R 2300/70

(57) ABSTRACT

A display control method of a display unit for a rider provided in an inverted vehicle, the inverted vehicle controlling a traveling state according to a change in a posture of the rider, in which display control is carried out according to procedures including the following steps by a control apparatus included in the inverted vehicle: a determination step that determines which of a plurality of traveling state patterns the traveling state according to the change in the posture of the inverted vehicle corresponds to, the plurality of traveling state patterns defined in advance as the patterns the inverted vehicle may take when the rider has a specific intention; and a display step that displays information according to the rider's intention corresponding to the traveling state pattern that is determined to correspond to the traveling state of the inverted vehicle on the display unit of the inverted vehicle.

### INCORPORATION BY REFERENCE

This application is based upon and claims the benefit of priority from Japanese patent application No. 2014-002227, filed on Jan. 9, 2014, the disclosure of which is incorporated herein in its entirety by reference.

### BACKGROUND OF THE INVENTION

1. Field of the Invention

The present invention relates to a display control method for inverted vehicle, and more specifically, to control in an inverted vehicle to control a traveling state according to a change in a posture of the inverted vehicle changed by a rider.

2. Description of Related Art

Japanese Unexamined Patent Application Publication No. 2012-58476 discloses a content output system to output appropriate content according to a situation. The content output system calculates, based on captured images obtained when an image capture device takes images in an image capture range, a change in the moving speed of one passerby. When there is a passerby whose moving speed is decreased in the image capture range, the passerby is paying attention to the content, and therefore the content output system switches content to be outputted by a content output device from ordinary content to specific content. On the other hand, when only passersby who are moving at constant speed are present in the image capture range, the passersby are not paying attention to the content, and hence the content output device continues to output the ordinary content.

### SUMMARY OF THE INVENTION

However, the content output system disclosed in Japanese Unexamined Patent Application Publication No. 2012-58476 takes images of a passerby by the image capture device fixedly arranged at a position apart from the passerby and outputs content by the content output device arranged at the same place as the image capture device. There is no technique for providing a rider of an inverted vehicle with appropriate information according to a rider's intention.

The present invention has been made in order to solve the aforementioned problems, and aims to provide a display control method for inverted vehicle capable of providing a rider of an inverted vehicle with appropriate information according to a rider's intention.

A display control method according to a first aspect of the present invention is a display control method of a display unit for a rider provided in an inverted vehicle, the inverted vehicle controlling a traveling state according to a change in a posture of the rider, the posture being varied by the rider, in which display control is carried out according to procedures including the following steps by a control apparatus included in the inverted vehicle: a determination step that determines which of a plurality of traveling state patterns the traveling state according to the change in the posture of the inverted vehicle corresponds to, the plurality of traveling state patterns defined in advance as the patterns the inverted vehicle may take when the rider has a specific intention; and a display step that displays information according to the rider's intention corresponding to the traveling state pattern that is determined to correspond to the traveling state of the inverted vehicle on the display unit of the inverted vehicle.

According to the above configuration, information to be provided to the rider is determined from the traveling state according to the change in the posture of the inverted vehicle which is closely related to the rider's intention, whereby it is possible to provide the rider with appropriate information according to the rider's intention.

Further, in the display control method, the plurality of traveling state patterns may further include at least one of a traveling state pattern of a stop state and a traveling state pattern of an intermittent traveling state defined to be one state the inverted vehicle may take when the rider has an intention of looking at an interesting object, and the display control method may further include a position storing step that stores, when it is determined that the traveling state of the inverted vehicle corresponds to the traveling state pattern of the stop state or the intermittent traveling state, positional information indicating a current position in a storage unit of the inverted vehicle as a place in which the rider is interested. It is therefore possible to accurately grasp the target in which the rider is interested by the positional information stored in the storage unit.

Furthermore, in the display control method, the plurality of traveling state patterns may further include a traveling state pattern of a deceleration state, which is one state the inverted vehicle may take when the rider has an intention of avoiding something, and the display control method may further include: a position storing step that stores, when it is determined that the traveling state of the inverted vehicle corresponds to the traveling state pattern of the deceleration state, positional information indicating a current position in a storage unit of the inverted vehicle as a place requiring attention; and an alerting step that displays, when the inverted vehicle approaches the position indicated by the positional information stored in the storage unit, an alerting indication on the display unit. It is therefore possible for the rider to carry out avoidance behavior to prevent a contact of the inverted vehicle with an obstacle according to an alerting indication at an early stage, whereby it is possible to further improve the security level.

Furthermore, in the display control method, the plurality of traveling state patterns may further include a traveling state pattern of the stationary traveling state and a traveling state pattern of the stop state, the stationary traveling state being defined to be one state the inverted vehicle may take when the rider has an intention of trying to move to a destination, the stop state being defined to be one state the inverted vehicle may take when the rider has an intention of trying to determine the destination, and in the display step, map information may be displayed as the information according to the rider's intention when it is determined that the traveling state of the inverted vehicle corresponds to the traveling state pattern of the stationary traveling state and information indicating a candidate of a destination may be displayed as the information according to the rider's intention when it is determined that the traveling state of the inverted vehicle corresponds to the traveling state pattern of the stop state. It is therefore possible to provide the rider with appropriate information according to the rider's intention in an environment in which the rider determines the destination and travels to the destination.

Still further, in the display control method, the inverted vehicle is used in a shopping mall including a plurality of shops, the plurality of traveling state patterns may include a traveling state pattern of a stationary traveling state and a traveling state pattern of a stop state, the stationary traveling state being defined to be one state the inverted vehicle may take when the rider has an intention of trying to move to a shop, the stop state being defined to be one state the inverted vehicle may take when the rider has an intention of trying to search for the shop, and in the display step, map information may be displayed as the information according to the rider's intention when it is determined that the traveling state of the inverted vehicle corresponds to the traveling state pattern of the stationary traveling state and shop information may be displayed as the information according to the rider's intention when it is determined that the traveling state of the inverted vehicle corresponds to the traveling state pattern of the stop state. It is therefore possible to provide the rider with appropriate information according to the rider's intention in the shopping mall.

Furthermore, in the display control method, the inverted vehicle may control the traveling state so that the inverted vehicle travels in a direction in which the posture of the inverted vehicle is inclined more than a predetermined reference posture and in a direction in which the posture of the inverted vehicle changes, and in the stationary traveling state, control to move the inverted vehicle in a direction opposite to the traveling direction according to the posture of the inverted vehicle which is inclined in the direction opposite to the traveling direction with respect to the reference posture in a state in which the posture of the inverted vehicle is inclined in the direction opposite to the traveling direction with respect to the reference posture and control to move the inverted vehicle in the traveling direction according to the change in the posture of the inverted vehicle to the traveling direction by the rider are cancelled with each other so that the inverted vehicle travels at a constant rate, and in the determination step, it may be determined that the traveling state of the inverted vehicle corresponds to the traveling state pattern of the traveling state when the inclination of the posture of the inverted vehicle with respect to the reference posture is larger than a first threshold, and it may be determined that the traveling state of the inverted vehicle corresponds to the traveling state pattern of the stop state when the inclination of the posture of the inverted vehicle with respect to the reference posture is smaller than a second threshold which is equal to or smaller than the first threshold. It is therefore possible to determine the traveling state of the inverted vehicle by a simple determination of comparing the change in the posture of the inverted vehicle with thresholds using the characteristics of the change in the posture of the inverted vehicle.

Furthermore, in the display control method, the plurality of traveling state patterns may further include a traveling state pattern of an acceleration/deceleration state and a traveling state pattern of an intermittent traveling state, the acceleration/deceleration state being defined to be one state the inverted vehicle may take when the rider has an intention of trying to move to a shop, the intermittent traveling state being defined to be one state the inverted vehicle may take when the rider has an intention of trying to select an item to purchase at the shop, and in the display step, map information may further be displayed as information according to the rider's intention when it is determined that the traveling state of the inverted vehicle corresponds to the traveling state pattern of the acceleration/deceleration state, and advertising information of the shop may further be displayed as information according to the rider's intention when it is determined that the traveling state of the inverted vehicle corresponds to the traveling state pattern of the intermittent traveling state. It is therefore possible to provide the rider with appropriate information according to the rider's intention in more detail.

According to each aspect of the present invention described above, it is possible to provide a display control method for inverted vehicle capable of providing a rider of an inverted vehicle with appropriate information according to a rider's intention.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a diagram showing an external configuration of an inverted two-wheeled vehicle according to a first embodiment;

FIG. 2 is a block diagram showing an internal configuration of the inverted two-wheeled vehicle according to the first embodiment;

FIG. 3 is a diagram showing travelling state patterns of the inverted two-wheeled vehicle according to the first embodiment;

FIG. 4 is a diagram showing travelling state patterns of the inverted two-wheeled vehicle according to the first embodiment;

FIG. 5 is a flowchart showing processing of the inverted two-wheeled vehicle according to the first embodiment;

FIG. 6 is a flowchart showing processing of an inverted two-wheeled vehicle according to a second embodiment; and

FIG. 7 is a flowchart showing processing of an inverted two-wheeled vehicle according to a third embodiment.

### DESCRIPTION OF THE EXEMPLARY EMBODIMENTS

Hereinafter, with reference to the drawings, preferred embodiments of the present invention will be described. The specific numerical values and the like shown in the following embodiments are merely examples for facilitating understanding of the invention and are not directed to limit the scope of the invention if not otherwise specified. Further, in the following description and the drawings, for the sake of clarification of the description, matters obvious for one of ordinary skilled in the art are omitted and simplified as appropriate.

### First Embodiment

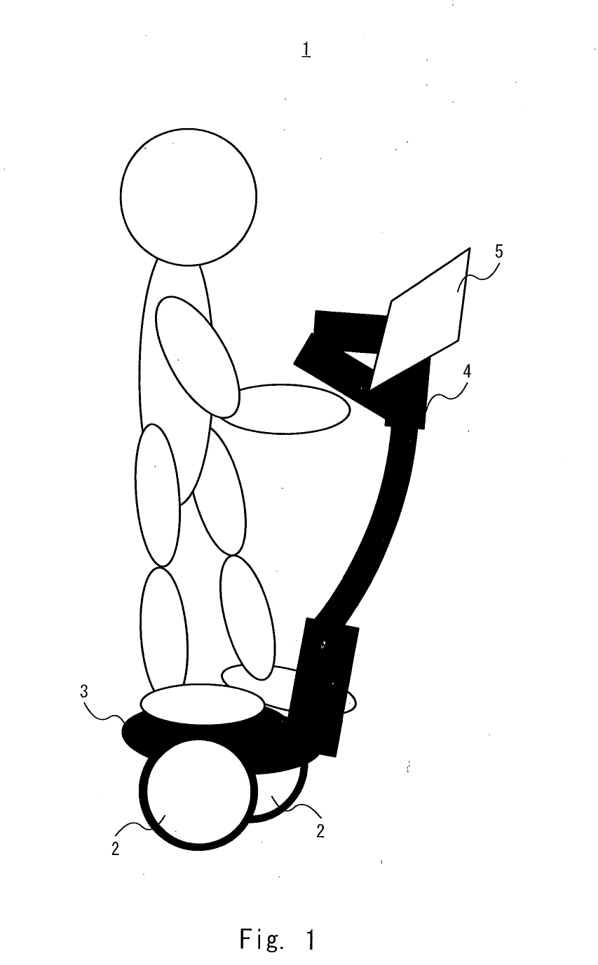

First, a first embodiment according to the present invention will be described. With reference to FIG. 1, an external configuration of an inverted two-wheeled vehicle 1 according to the first embodiment will be described. FIG. 1 is a diagram showing a schematic configuration of the inverted two-wheeled vehicle 1 according to the first embodiment. While a case in which the inverted two-wheeled vehicle 1 is used in a shopping mall will be described below, the inverted two-wheeled vehicle 1 may be used in other places.

The inverted two-wheeled vehicle 1 includes a pair of right and left wheels 2, a step cover 3, a handle 4, and a display 5.

The right and left wheels 2 are attached to both ends of the body of the inverted two-wheeled vehicle 1. The inverted two-wheeled vehicle 1 travels by the rotation of the wheels 2. The step cover 3 is provided on the upper surface of the body of the inverted two-wheeled vehicle 1. A rider can get on the step cover 3. The handle 4 is attached to the front part of the body of the inverted two-wheeled vehicle 1 and extends upwardly so as to allow the rider who gets on the step cover 3 to hold the handle 4 with both hands.

The display 5 is a display apparatus that is able to display an arbitrary type of information. The display 5 shows, for example, map information indicating the map of the shopping mall, shop information indicating shops in the shopping mall, and advertising information indicating advertisements of the shops. The display 5 is attached to the handle 4 such that the display surface of the display 5 is opposed to the rider to allow the rider to look at the information displayed on the display 5. The display 5 may be any display apparatus such as a liquid crystal display, a plasma display, and an organic EL display.

The inverted two-wheeled vehicle 1 rotates the right and left wheels 2 to keep the inverted state of the inverted two-wheeled vehicle 1 according to a change in the posture of the inverted two-wheeled vehicle 1 in the front-back direction. The posture can be changed by the rider who holds the handle 4 and gets on the step cover 3 applying a load to the inverted two-wheeled vehicle 1 in the front-back direction. In summary, when the rider inclines the posture of the inverted two-wheeled vehicle 1 forwardly, the inverted two-wheeled vehicle 1 travels in the forward direction so as to maintain the inverted state of the inverted two-wheeled vehicle 1. On the other hand, when the rider inclines the posture of the inverted two-wheeled vehicle 1 backwardly, the inverted two-wheeled vehicle 1 rotates the right and left wheels 2 to travel in the backward direction so as to maintain the inverted state of the inverted two-wheeled vehicle 1.

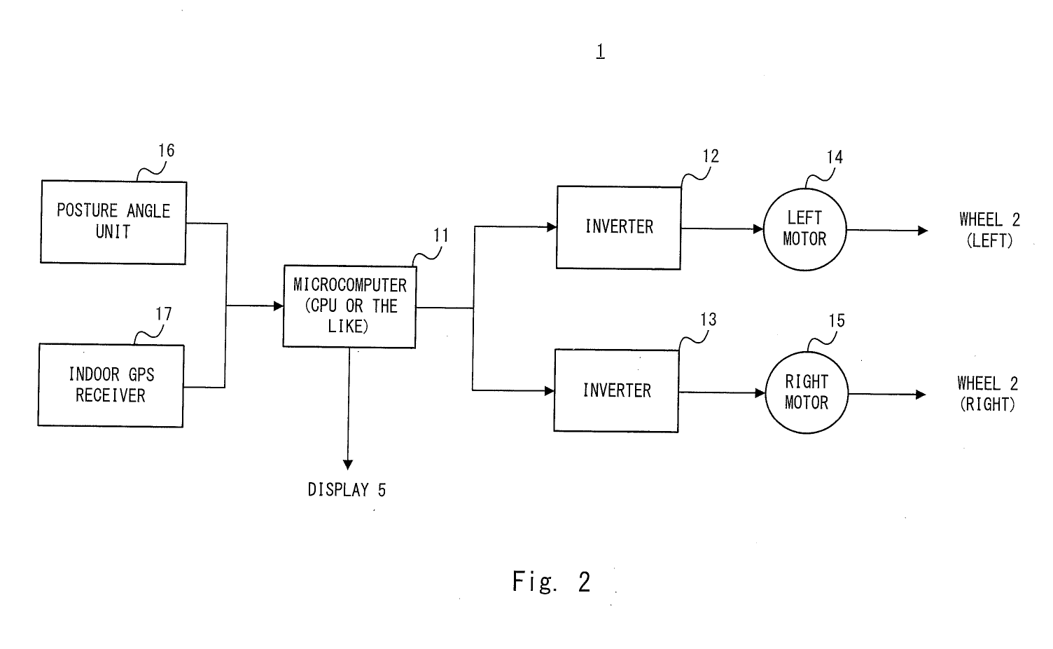

Referring next to FIG. 2, an internal configuration of the inverted two-wheeled vehicle 1 according to the first embodiment will be described. FIG. 2 is a block diagram showing the internal configuration of the inverted two-wheeled vehicle 1 according to the first embodiment.

The inverted two-wheeled vehicle 1 includes a microcontroller 11, inverters 12 and 13, motors 14 and 15, a posture angle unit 16, and an indoor GPS (Global Positioning System) receiver 17. The set including the units 11-17 functions as a control apparatus.

The inverted two-wheeled vehicle 1 may include another set of the units 11-13, 16, and 17 stated above and motors 14 and 15 that are double winding motors so as to duplex the control system including the units 11-13, 16, and 17. Accordingly, when there is an abnormality in one control system, the other control system can be used to continuously control the inverted two-wheeled vehicle 1, thereby improving the safety level to control the inverted two-wheeled vehicle 1. Alternatively, three or more control systems may be provided for multiplexing the control systems.

The microcomputer 11 is an electronic control unit (ECU) that controls the motors 14 and 15 so as to maintain the inverted state of the inverted two-wheeled vehicle 1 as described above based on a posture angle signal output from the posture angle unit 16. The microcomputer 11 includes a central processing unit (CPU) and a storage unit, and executes a program stored in the storage unit to execute processing as the microcomputer 11 according to this embodiment. Specifically, the program stored in the storage unit of the microcomputer 11 includes a code that causes the CPU to execute processing in the microcomputer 11 according to this embodiment. The storage unit includes, for example, a storage device that is capable of storing this program and various types of information used for the processing in the CPU. The storage device may be at least one desired storage device selected from storage devices such as a memory and a hard disc.

The microcomputer 11 outputs command values to control the motor 14 to the inverter 12. The microcomputer 11 further outputs command values to control the motor 15 to the inverter 13. Specifically, the microcomputer 11 generates command values to control the motors 14 and 15 so as to maintain the inverted state of the inverted two-wheeled vehicle 1 based on an angular velocity around a pitch axis (pitch angular velocity) and a posture angle (pitch angle) around the pitch axis of the inverted two-wheeled vehicle 1 indicated by the posture angle signal output from the posture angle unit 16.

More specifically, when the pitch angle is an angle at which the posture of the inverted two-wheeled vehicle 1 is inclined forwardly compared to a predetermined reference posture, the microcomputer 11 generates command values to cause the inverted two-wheeled vehicle 1 to travel in the forward direction. Meanwhile, when the pitch angle is an angle at which the posture of the inverted two-wheeled vehicle 1 is inclined rearwardly compared to the above reference posture, the microcomputer 11 generates command values to cause the inverted two-wheeled vehicle 1 to travel in the backward direction. The microcomputer 11 generates command values to further accelerate the inverted two-wheeled vehicle 1 with increasing gradient of the posture of the inverted two-wheeled vehicle 1 with respect to the above reference posture (angle made by the reference posture and the posture of the inverted two-wheeled vehicle 1). In the following description, when the pitch angle is an angle at which the posture of the inverted two-wheeled vehicle 1 is inclined forwardly compared to the reference posture, the pitch angle is represented as a positive value. Meanwhile, when the pitch angle is an angle at which the posture of the inverted two-wheeled vehicle 1 is inclined forwardly compared to the reference posture, the pitch angle is represented as a negative value.

Further, in a case in which the pitch angular velocity occurs forwardly, the microcomputer 11 generates command values to cause the inverted two-wheeled vehicle 1 to travel in the forward direction. Meanwhile, in a case in which the pitch angular velocity occurs rearwardly, the microcomputer 11 generates command values to cause the inverted two-wheeled vehicle 1 to travel in the backward direction. The microcomputer 11 generates command values to further accelerate the inverted two-wheeled vehicle 1 with increasing pitch angular velocity.

As stated above, the microcomputer 11 controls the traveling state of the inverted two-wheeled vehicle 1 so that the inverted two-wheeled vehicle 1 travels in a direction in which the posture of the inverted two-wheeled vehicle 1 is more inclined than the reference posture and travels in a direction in which the posture of the inverted two-wheeled vehicle 1 changes. According to such control, in principle, the inverted two-wheeled vehicle 1 travels forward when the rider changes the posture of the inverted two-wheeled vehicle 1 in the forward direction and travels rearward when the rider changes the posture of the inverted two-wheeled vehicle 1 in the rearward direction. Another situation may also occur in which a direction calculated as the direction to move the inverted two-wheeled vehicle 1 by the pitch angle and a direction calculated as the direction to move the inverted two-wheeled vehicle 1 by the pitch angular velocity are opposite from each other. In this case, the inverted two-wheeled vehicle 1 travels or is accelerated in the direction obtained by canceling the calculation results. Even when the posture of the inverted two-wheeled vehicle 1 is inclined rearwardly compared to the reference posture and the change in the posture of the inverted two-wheeled vehicle 1 is towards the front, for example, the inverted two-wheeled vehicle 1 is controlled to travel forward if there is a slight inclination of the posture in the rearward direction and there is an extremely rapid change in the posture in the forward direction.

The phrase “the case in which the pitch angular velocity occurs forwardly” means, when the front side of the inverted two-wheeled vehicle 1 is the right side and the rear side of the inverted two-wheeled vehicle 1 is the left side as shown in FIG. 1, the angular velocity that occurs in the clockwise direction. Further, the phrase “the case in which the pitch angular velocity occurs rearwardly” means, when the front side of the inverted two-wheeled vehicle 1 is the right side and the rear side of the inverted two-wheeled vehicle 1 is the left side as shown in FIG. 1, the angular velocity that occurs in the counterclockwise direction.

The inverted two-wheeled vehicle 1 may employ, as the posture angle unit 16, a posture angle unit that does not detect the angular velocities of a plurality of axes (e.g., pitch axis, roll axis, and yaw axis) including the pitch angular velocity and only detects the angle of a plurality of axes including the pitch angle. In this case, the microcomputer 11 may differentiate the pitch angle indicated by the posture angle signal output from the posture angle unit 16 to calculate the pitch angular velocity.

Further, the microcomputer 11 outputs image information indicating images of the map information, the shop information, and the advertising information stated above to the display 5. The display 5 is therefore able to display the map information, the shop information, and the advertising information as images indicated by the image information output from the microcomputer 11. The image information of the map information, the shop information, and the advertising information may be stored, for example, in the storage unit of the microcomputer 11, and the microcomputer 11 may acquire, from the storage unit, the image information to be displayed to output the acquired information to the display 5. In this case, the image information stored in the storage unit may not be directly output and the image information may be, for example, changed or synthesized as appropriate. When the map information is displayed, for example, the microcomputer 11 may change the map information so that the map information also indicate at least one of the current position of the inverted two-wheeled vehicle 1 indicated by the positional information from the indoor GPS receiver 17 and the route to the destination (target shop).

The inverter 12 carries out a pulse width modulation (PWM) control based on the command values output from the microcomputer 11, thereby generating a drive current to drive the motor 14 to supply the drive current to the motor 14. The inverter 13 carries out the PWM control based on the command values output from the microcomputer 11, thereby generating a drive current to drive the motor 15 to supply the drive current to the motor 15.

The motor 14 is driven based on the drive current supplied from the inverter 12. The drive of the motor 14 causes the rotation of the left wheel 2 of the inverted two-wheeled vehicle 1. The motor 15 is driven based on the drive current supplied from the inverter 13. The drive of the motor 15 causes the rotation of the right wheel 2 of the inverted two-wheeled vehicle 1.

The posture angle unit 16 is a sensor that detects the angles of the plurality of axes including the pitch angle of the inverted two-wheeled vehicle 1 and the angular velocities of the plurality of axes, the pitch angle being changed by the rider applying a load to the step cover 3 of the inverted two-wheeled vehicle 1 in the front-back direction. The posture angle unit 16 generates a posture angle signal indicating the angles of the plurality of axes including the pitch angle that is detected and the angular velocities of the plurality of axes including the pitch angular velocity to output the posture angle signal to the microcomputer 11. The posture angle unit 16 may be included in the body of the inverted two-wheeled vehicle 1 or may be included in the handle 4.

The indoor GPS receiver 17 receives positional information transmitted from indoor GPS transmitters installed in a plurality of arbitrary places in the shopping mall, and transmits the received positional information to the microcomputer 11. The positional information indicates the position of the indoor GPS transmitter. The microcomputer 11 is therefore able to grasp the position of the indoor GPS transmitter indicated by the positional information as the current position. The indoor GPS receiver 17 and the indoor GPS transmitter conform to, for example, the Indoor Messaging System (IMES).

The first embodiment directs attention to the fact that the traveling state according to a change in the posture of the inverted two-wheeled vehicle 1 can be categorized into a plurality of traveling state patterns indicating a rider's intention, and the information according to the rider's intention is displayed on the display 5 based on the traveling state according to the change in the posture of the inverted two-wheeled vehicle 1.

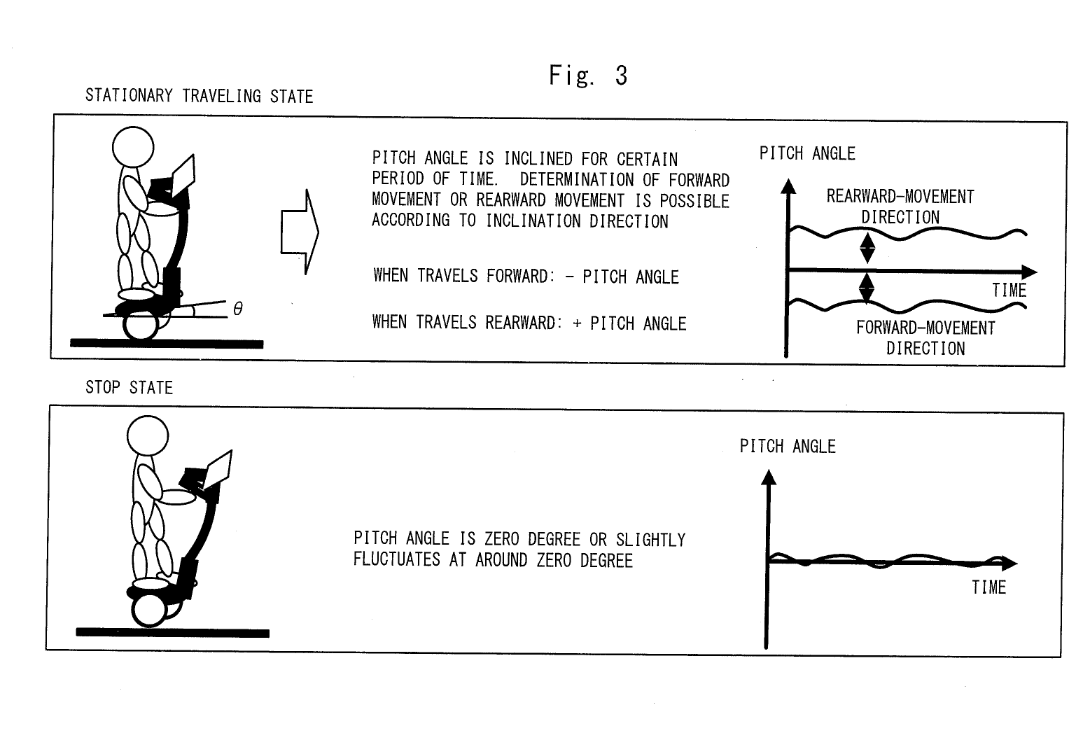

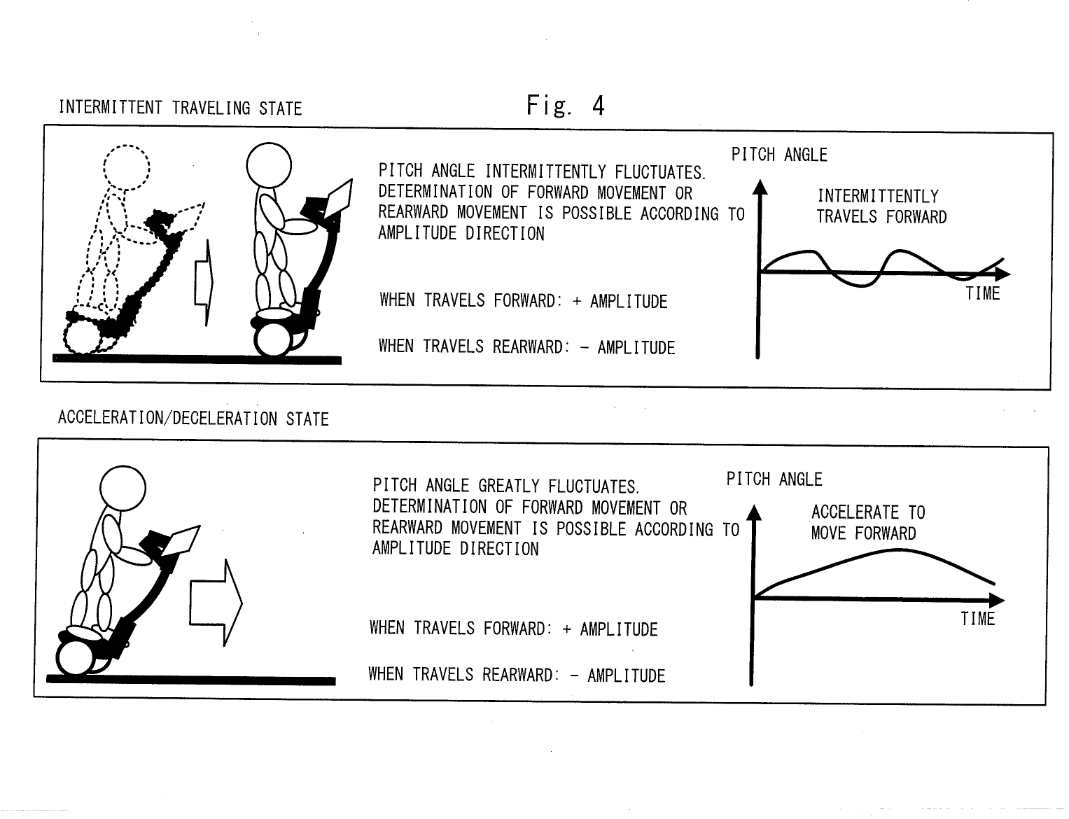

Referring next to FIGS. 3 and 4, traveling state patterns of the inverted two-wheeled vehicle 1 according to the first embodiment will be described. FIGS. 3 and 4 are diagrams showing traveling state patterns of the inverted two-wheeled vehicle 1 according to the first embodiment. As shown in FIGS. 3 and 4, the traveling state patterns of the inverted two-wheeled vehicle 1 correspond to the operating states of the inverted two-wheeled vehicle 1.

The traveling state of the inverted two-wheeled vehicle 1 can be categorized into four traveling state patterns of the inverted two-wheeled vehicle 1 as shown in FIGS. 3 and 4. That is, the state of the inverted two-wheeled vehicle 1 can be categorized into four states of a “stationary traveling state”, a “stop state”, an “intermittent traveling state”, and an “acceleration/deceleration state”.

### (1) Stationary Traveling State

The stationary traveling state is a traveling state pattern in which the inverted two-wheeled vehicle 1 travels substantially at a constant rate. When the inverted two-wheeled vehicle 1 is in the stationary traveling state and travels forward substantially at a constant rate, the inverted two-wheeled vehicle 1 travels with the pitch angle at which the posture of the inverted two-wheeled vehicle 1 is inclined rearwardly compared to the reference posture. In other words, the inverted two-wheeled vehicle 1 travels with a negative pitch angle. On the other hand, when the inverted two-wheeled vehicle 1 is in the stationary traveling state and travels rearward substantially at a constant rate, the inverted two-wheeled vehicle 1 travels with the pitch angle at which the posture of the inverted two-wheeled vehicle 1 is inclined forwardly compared to the reference posture. In other words, the inverted two-wheeled vehicle 1 travels with a positive pitch angle.

As described above, in the state in which the inverted two-wheeled vehicle 1 travels at a constant rate, the posture of the inverted two-wheeled vehicle 1 is inclined at a constant gradient in the direction opposite to the traveling direction. This is because, in a control calculation (command value calculation) of the inverted two-wheeled vehicle 1 by the microcomputer 11, control to move the inverted two-wheeled vehicle 1 in a direction opposite to the traveling direction according to the posture (pitch angle) inclined in the direction opposite to the traveling direction with respect to the reference posture and control to move the inverted two-wheeled vehicle 1 in the traveling direction according to the change in the posture (pitch angular velocity) in the traveling direction caused by the rider trying to move the inverted two-wheeled vehicle 1 in the traveling direction are canceled with each other so that the control calculation is carried out to calculate the command value to move the inverted two-wheeled vehicle 1 at a constant rate.

Accordingly, when the state in which the absolute value of the pitch angle is larger than a predetermined threshold (first angle threshold) continues for a time longer than a predetermined threshold (first time threshold), the microcomputer 11 determines that the inverted two-wheeled vehicle 1 is in the “stationary traveling state”.

When it is determined that the inverted two-wheeled vehicle 1 is in the “stationary traveling state”, it is estimated that the rider is traveling with the inverted two-wheeled vehicle 1 and has an intention of moving to the destination (target shop). In summary, it is estimated that the rider desires to look at the map (or at least one of the current position of the inverted two-wheeled vehicle 1 and the route to the destination in addition to the map). Accordingly, in this case, the microcomputer 11 displays the map information on the display 5 as the information according to the rider's intention. In summary, the image of the map of the shopping mall is displayed on the display 5.

At this time, as described above, the microcomputer 11 may indicate at least one of the current position of the inverted two-wheeled vehicle 1 indicated by the positional information from the indoor GPS receiver 17 and the route to the destination (target shop) as the map information. The microcomputer 11 may indicate, for example, the icon of the inverted two-wheeled vehicle 1 at the position indicated by the positional information in the map information. Alternatively, the microcomputer 11 may calculate, for example, the route to the destination using a typical route search technique and indicate the route that is calculated as the map information.

### (2) Stop State

The stop state means a traveling state pattern in which the inverted two-wheeled vehicle 1 is stopped. In the stop state, the pitch angle of the inverted two-wheeled vehicle 1 remains at the zero degree or slightly fluctuates at around the zero degree. In summary, in the stop state, the posture of the inverted two-wheeled vehicle 1 is coincident with the reference posture or slightly fluctuates at around the reference posture.

Accordingly, the microcomputer 11 determines that the inverted two-wheeled vehicle 1 is in the “stop state” when the state in which the absolute value of the pitch angle is smaller than a predetermined threshold (second angle threshold (e.g., a value equal to or smaller than the first angle threshold) continues for a time longer than a predetermined threshold (second time threshold), the inverted two-wheeled vehicle 1 is determined to be in the “stop state”.

When it is determined that the inverted two-wheeled vehicle 1 is in the “stop state”, it is estimated that the rider has an intention of stopping the inverted two-wheeled vehicle 1 to determine the target shop. Accordingly, in this case, the microcomputer 11 displays the shop information on the display 5 as the information according to the rider's intention. In summary, the image indicating the shop in the shopping mall is displayed on the display 5.

Note that the shop information may be any type of information as long as the shop information indicates the shop in the shopping mall. The shop information may be, for example, a floor map indicating each shop in the shopping mall or may be a shop list indicating each shop in the shopping mall. Further, the rider may select and determine the target shop from the shop information displayed on the display 5 through an input device (not shown) included in the inverted two-wheeled vehicle 1. The input device may be, for example, the display 5 which is a touch panel, or may be operation buttons provided in the inverted two-wheeled vehicle 1 separately from the display 5. The microcomputer 11 may recognize the shop that is selected and determined according to the input through the input device as the destination and calculate and display the route to the destination when the map information is displayed. In summary, in this case, the shop information functions as the information indicating the candidate of the destination.

### (3) Intermittent Traveling State

The intermittent traveling state is a traveling state pattern in which the inverted two-wheeled vehicle 1 intermittently travels. In the intermittent traveling state, the inverted two-wheeled vehicle 1 travels with the pitch angle fluctuating with reference to the zero degree. That is, in the intermittent traveling state, the inverted two-wheeled vehicle 1 travels while repeating a state in which the posture of the inverted two-wheeled vehicle 1 is inclined forwardly compared to the reference posture and a state in which it is inclined rearwardly compared to the reference posture.

Accordingly, when the state in which the absolute value of the pitch angle is larger than a predetermined threshold (third angle threshold (e.g., a value equal to or larger than the second angle threshold) is ended at a time shorter than a predetermined threshold (third time threshold (e.g., time shorter than the first time threshold), the microcomputer 11 determines that the inverted two-wheeled vehicle 1 is in the “intermittent traveling state”.

When it is determined that the inverted two-wheeled vehicle 1 is in the “intermittent traveling state”, it is estimated that the rider gradually moves the inverted two-wheeled vehicle 1 and has an intention of selecting the items to purchase in the shop. In summary, it is estimated that the rider desires to get best-buy item information. Accordingly, in this case, the microcomputer 11 displays the advertising information of the shop on the display 5 as the information according to the rider's intention. In summary, the image indicating the advertisement of the shop is displayed on the display 5.

The advertisement of the shop at which the inverted two-wheeled vehicle 1 (rider) is present is displayed as the advertising information. The position of the shop at which the inverted two-wheeled vehicle 1 is present may be specified by the microcomputer 11 by comparing the current position of the inverted two-wheeled vehicle 1 indicated by the positional information output from the indoor GPS receiver 17 with the map information stored in the storage unit and determining at which shop in the map information the inverted two-wheeled vehicle 1 is present. The microcomputer 11 then acquires, from the storage unit, the advertising information of the shop specified that the inverted two-wheeled vehicle 1 is present among the plurality of pieces of advertising information stored in the storage unit, and displays the advertising information that is acquired on the display 5. When it is determined that the inverted two-wheeled vehicle 1 is not present at any of the shops, the advertising information may not be displayed or the advertising information of the shop which is the closest to the inverted two-wheeled vehicle 1 may be displayed instead.

### (4) Acceleration/Deceleration State

The acceleration/deceleration state is a traveling state pattern in which the inverted two-wheeled vehicle 1 accelerates or decelerates. In the acceleration/deceleration state, the inverted two-wheeled vehicle 1 travels at a pitch angle that greatly fluctuates. In summary, in the acceleration/deceleration state, the inverted two-wheeled vehicle 1 travels in a state in which the posture of the inverted two-wheeled vehicle 1 is greatly inclined in the traveling direction.

Accordingly, when the absolute value of the pitch angle is larger than a predetermined threshold (fourth angle threshold (e.g., a threshold larger than the first angle threshold and the third angle threshold), the microcomputer 11 determines that the inverted two-wheeled vehicle 1 is in the “acceleration/deceleration state”.

When the inverted two-wheeled vehicle 1 is determined to be in the “acceleration/deceleration state”, it is estimated that the rider is travelling with the inverted two-wheeled vehicle 1 and has an intention of moving to the destination (target shop). In summary, it is estimated that the rider desires to look at the map (or at least one of the current position of the inverted two-wheeled vehicle 1 and the route to the destination in addition to the map). Accordingly, in this case, the microcomputer 11 displays the map information on the display 5 as the information according to the rider's intention.

In this case as well, similar to the “stationary traveling state”, the microcomputer 11 may display at least one of the current position of the inverted two-wheeled vehicle 1 indicated by the positional information from the indoor GPS receiver 17 and the route to the destination (target shop) in the map information.

In this way, in the first embodiment, the change in the posture of the inverted two-wheeled vehicle 1 and the traveling state according to the change can be closely related to the rider's intention. Accordingly, it is determined which of the traveling state patterns the traveling state of the inverted two-wheeled vehicle 1 corresponds to, the traveling state patterns defined in advance as the patterns the inverted two-wheeled vehicle 1 may take when the rider has a specific intention and the information according to the corresponding traveling state pattern is displayed on the display 5, whereby it is possible to provide the rider with appropriate information according to the rider's intention.

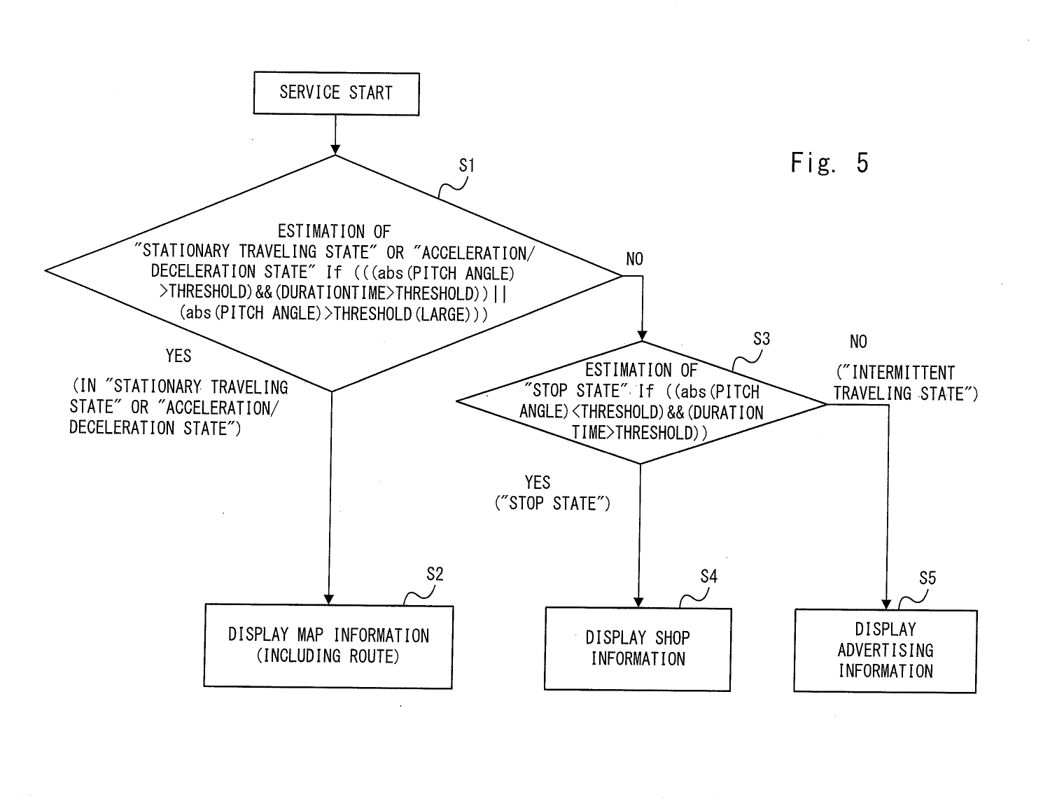

Referring next to FIG. 5, processing of the inverted two-wheeled vehicle 1 according to the first embodiment will be described. FIG. 5 is a flowchart showing the processing of the inverted two-wheeled vehicle 1 according to the first embodiment.

The microcomputer 11 determines whether the inverted two-wheeled vehicle 1 is in the “stationary traveling state” or in the “acceleration/deceleration state” based on the change in the pitch angle indicated by the posture angle signal output from the posture angle unit 16 (S1). Specifically, the microcomputer 11 determines whether the state in which the absolute value of the pitch angle is larger than the first angle threshold continues for a time longer than the first time threshold, and whether the absolute value of the pitch angle is larger than the fourth angle threshold.

When it is determined that the inverted two-wheeled vehicle 1 is in the “stationary traveling state” or the “acceleration/deceleration state” (S1: Yes), the microcomputer 11 displays the map information on the display (S2).

When it is determined that the inverted two-wheeled vehicle 1 is neither in the “stationary traveling state” nor in the “acceleration/deceleration state” (S1: No), the microcomputer 11 determines whether the inverted two-wheeled vehicle 1 is in the “stop state” (S3). Specifically, the microcomputer 11 determines whether the state in which the absolute value of the pitch angle is smaller than the second angle threshold has continued for a time longer than the second time threshold.

When it is determined that the inverted two-wheeled vehicle 1 is in the “stop state” (S3: Yes), the microcomputer 11 displays the shop information on the display 5 (S4). When it is determined that the inverted two-wheeled vehicle 1 is not in the “stop state” (S3: No), it is specified by the elimination method that the inverted two-wheeled vehicle 1 is in the “intermittent traveling state”. In this case, the microcomputer 11 displays the advertising information on the display 5 (S5).

While it is first determined whether the inverted two-wheeled vehicle 1 is in the “stationary traveling state” or the “acceleration/deceleration state”, then determined whether the inverted two-wheeled vehicle 1 is in the “stop state”, and the “intermittent traveling state” is specified by the elimination method in the above description, the combination of the order of determining the operating state and the operating state determined by the elimination method is not limited to the above example and may be arbitrarily combined. For example, it may be first determined whether the inverted two-wheeled vehicle 1 is in the “stop state” and the shop information may be displayed when it is determined that the inverted two-wheeled vehicle 1 is in the stop state. When it is determined that the inverted two-wheeled vehicle 1 is not in the “stop state”, it may be determined whether the inverted two-wheeled vehicle 1 is in the “intermittent traveling state”. When it is determined that the inverted two-wheeled vehicle 1 is in the “intermittent traveling state”, the advertising information may be displayed. When it is determined that the inverted two-wheeled vehicle 1 is not in the “intermittent traveling state”, it may be determined that the inverted two-wheeled vehicle 1 is in the “stationary traveling state” or the “acceleration/deceleration state” by the elimination method and the map information may be displayed.

Further, the number of traveling state patterns is not limited to the above four states. The number of traveling state patterns may be categorized into three or less patterns or may be categorized into five or more patterns. The operating state of the inverted two-wheeled vehicle 1 may be categorized into, for example, two traveling state patterns of the “stop state” and the “stationary traveling state”, and it may be determined whether the inverted two-wheeled vehicle 1 is in the “stop state” according to the condition for determining the “stop state”. When it is determined that the inverted two-wheeled vehicle 1 is in the “stop state”, the shop information may be displayed. Meanwhile, when it is determined that the inverted two-wheeled vehicle 1 is not in the “stop state”, it may be determined by the elimination method that the inverted two-wheeled vehicle 1 is in the “stationary traveling state” and the map information may be displayed.

As described above, in the first embodiment, it is determined which of the plurality of traveling state patterns the traveling state according to the change in the posture of the inverted two-wheeled vehicle 1 (inverted vehicle) corresponds to, the plurality of traveling state patterns defined in advance as the patterns the inverted two-wheeled vehicle 1 may take when the rider has a specific intention, and the information according to the rider's intention corresponding to the traveling state pattern that is determined to correspond to the traveling state on the display 5 (display unit) of the inverted two-wheeled vehicle 1. It is therefore possible to determine the information provided for the rider from the traveling state according to the change in the posture of the inverted vehicle closely related to the rider's intention, whereby it is possible to provide the rider with appropriate information according to the rider's intention.

### Second Embodiment

First, a second embodiment of the present invention will be described. Since the external configuration and the internal configuration of the inverted two-wheeled vehicle 1 according to the second embodiment are similar to those in the first embodiment, the descriptions thereof will be omitted.

The inverted two-wheeled vehicle 1 according to the second embodiment is different from that of the first embodiment in that it further estimates and registers shops of interest based on the characteristics that a person frequently visits the shop in which the person is interested to look at items in the shop.

More specifically, when the inverted two-wheeled vehicle 1 is in the “intermittent traveling state” or the “stop state” in one shop, it is estimated that the rider gradually moves or stops the inverted two-wheeled vehicle 1 to look at items in the shop and is interested in the shop. In summary, it is estimated that the rider has an intention of looking at an interesting target. When the number of times the inverted two-wheeled vehicle 1 is in the “intermittent traveling state” or the “stop state” in the shop is larger than a predetermined threshold (visit frequency threshold), the microcomputer 11 determines that the rider is interested in the shop and registers the shop.

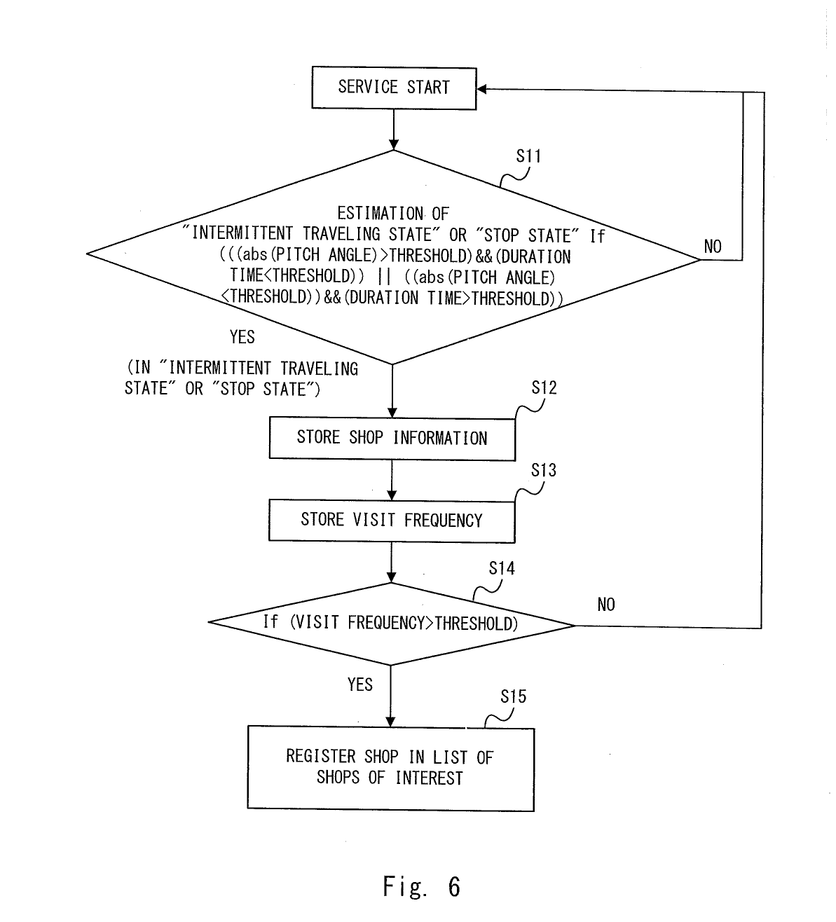

Referring next to FIG. 6, processing of the inverted two-wheeled vehicle 1 according to the second embodiment will be described. FIG. 6 is a flowchart showing the processing of the inverted two-wheeled vehicle 1 according to the second embodiment.

The microcomputer 11 determines whether the inverted two-wheeled vehicle 1 is in the “intermittent traveling state” or the “stop state” in one shop based on a change in the pitch angle indicated by the posture angle signal output from the posture angle unit 16 (S11). More specifically, the microcomputer 11 determines whether the state in which the absolute value of the pitch angle is larger than the third angle threshold has ended in a time shorter than the third time threshold and whether the state in which the absolute value of the pitch angle is smaller than the second angle threshold has continued for a period of time longer than the second time threshold. Whether the inverted two-wheeled vehicle 1 is in the shop may be determined by comparing the current position of the inverted two-wheeled vehicle 1 with the map information, as described above.

When it is determined that the inverted two-wheeled vehicle 1 is in the “intermittent traveling state” or in the “stop state” in the shop (S 11: Yes), the microcomputer 11 stores the shop information indicating the shop at which the inverted two-wheeled vehicle 1 is present in the storage unit and stores the frequency information indicative of the number of times that the inverted two-wheeled vehicle 1 has visited the shop in the storage unit (S12, S13). When the inverted two-wheeled vehicle 1 has visited the shop before and the shop information and the frequency information are stored in the storage unit, the microcomputer 11 updates the frequency information to count up the number of times that the inverted two-wheeled vehicle 1 has visited the shop indicated by the frequency information.

The microcomputer 11 determines whether the number of times that the inverted two-wheeled vehicle 1 has visited the shop indicated by the frequency information stored in the storage unit is larger than the visit frequency threshold (S14). When it is determined that the number of times that the inverted two-wheeled vehicle 1 has visited the shop is larger than the visit frequency threshold (S14: Yes), the microcomputer 11 registers the shop in the “list of the shops of interest” stored in the storage unit (S15).

According to the above configuration, by referring to the “list of the shops of interest” stored in the storage unit of the microcomputer 11, it is possible to grasp the consumers' needs based on the shops that are registered.

Further, it is also possible to provide the rider with more appropriate information using the “list of the shops of interest”. When the shop list is displayed as the shop information, for example, the shops registered in the “list of the shops of interest” may be preferentially displayed. This is more effective when the “list of the shops of interest” is stored for each rider. As an example, when the use of the inverted two-wheeled vehicle 1 is started, the rider inputs information to identify himself/herself (e.g., ID and password) through the input device of the inverted two-wheeled vehicle 1 to preferentially display the shops registered in the “list of the shops of interest”. Alternatively, the shops may be displayed in a descending order of the number of times that the inverted two-wheeled vehicle 1 has visited the shops indicated by the frequency information. The microcomputer 11 may then update the “list of the shops of interest” corresponding to the rider in the following operation of the inverted two-wheeled vehicle 1.

Further, the units of counting up the visit frequency and registering the visit frequency in the list is not limited to the units of shops and may be units of individual regions obtained by further dividing the shop. In this case, instead of registering a shop in the list as the place in which the rider is interested in, a specific place in the shop is registered in the list as the place in which the rider is interested in. In summary, in this case, a plurality of indoor GPS transmitters are provided in the shop. It is therefore possible to make an analysis regarding which item in the shop the consumers are interested in by referring to the list. Accordingly, it is possible to know as a reference which kind of items the shop should have to improve sales.

While the shop is registered in the “list of the shops of interest” when the visit frequency becomes larger than the visit threshold in the above description, the shop may be registered in the “list of the shops of interest” when the inverted two-wheeled vehicle 1 is determined to be in the “intermittent traveling state” or in the “stop state” without taking into account the number of times that the inverted two-wheeled vehicle 1 has visited the shop. Preferably, however, by taking into account the number of times that the inverted two-wheeled vehicle 1 has visited the shop as described above, it is possible to suppress excessive registration in the shop list and to improve the accuracy for registering only the shop in which the rider is really interested.

As described above, in the second embodiment, when it is determined that the traveling state of the inverted two-wheeled vehicle 1 (inverted vehicle) corresponds to the traveling state pattern of the intermittent traveling state or the stop state, the positional information indicating the current position is stored in the storage unit of the inverted two-wheeled vehicle 1 as a place in which the rider is interested. It is thereby possible to accurately grasp the target in which the rider is interested by the positional information stored in the storage unit.

### Third Embodiment

First, a third embodiment of the present invention will be described. Since the external configuration and the internal configuration of the inverted two-wheeled vehicle 1 according to the third embodiment are similar to those in the first embodiment, the descriptions thereof will be omitted.

Compared to the inverted two-wheeled vehicle 1 according to the first embodiment, the inverted two-wheeled vehicle 1 according to the third embodiment further presents an alerting indication when the inverted two-wheeled vehicle 1 approaches a place requiring attention based on the characteristics that the rider initiates emergency braking when trying to avoid something.

Specifically, when the inverted two-wheeled vehicle 1 is in the “acceleration/deceleration state”, it is estimated that emergency braking of the inverted two-wheeled vehicle 1 is initiated and the rider has an intention of avoiding something. It is estimated, for example, that the rider intends to avoid an obstacle. When the number of times that the inverted two-wheeled vehicle 1 is in the “acceleration/deceleration state” at one place is larger than a predetermined threshold (visit frequency threshold), the microcomputer 11 registers the place as a place requiring attention. When the inverted two-wheeled vehicle 1 approaches the place registered as the place requiring attention next time, the microcomputer 11 displays an alerting indication on the display 5.

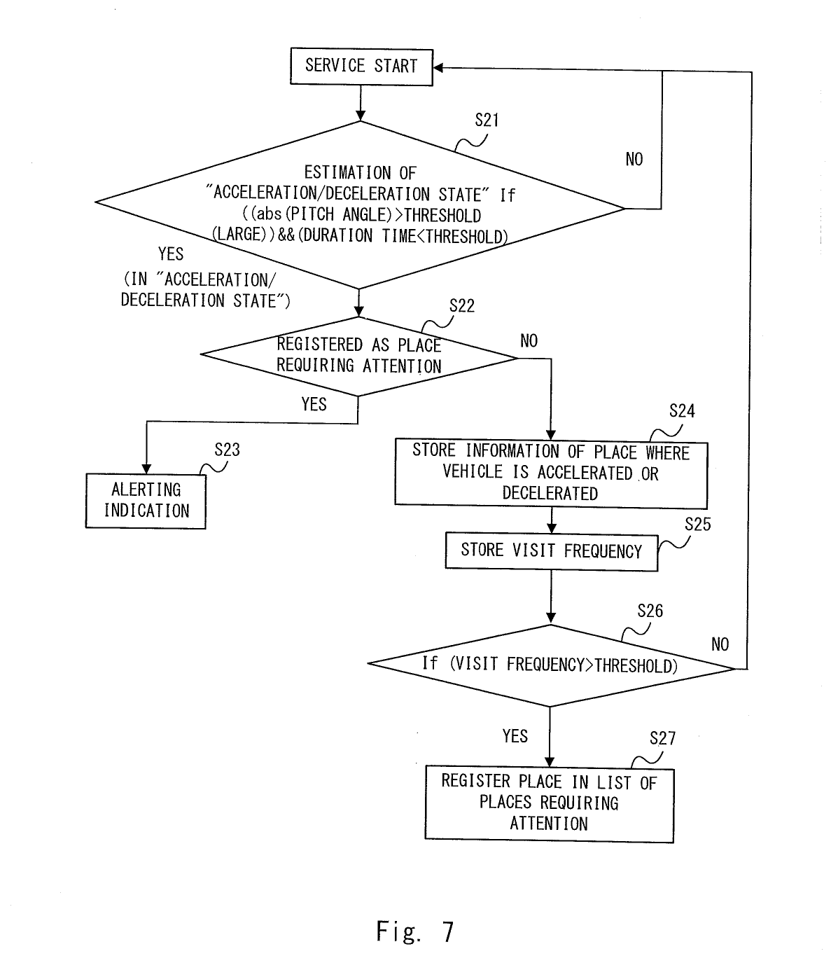

Referring next to FIG. 7, processing of the inverted two-wheeled vehicle 1 according to the third embodiment will be described. FIG. 7 is a flowchart showing the processing of the inverted two-wheeled vehicle 1 according to the third embodiment.

The microcomputer 11 determines whether the inverted two-wheeled vehicle 1 is in the “acceleration/deceleration state” based on the change in the pitch angle indicated by the posture angle signal output from the posture angle unit 16 (S21). Specifically, the microcomputer 11 determines whether the state in which the absolute value of the pitch angle is larger than the fourth angle threshold has ended in a time shorter than a predetermined threshold (fourth time threshold). In the third embodiment, as is different from the first embodiment, a condition regarding the fourth time threshold is added. It is therefore possible to detect the state of the emergency braking more accurately. Whether the inverted two-wheeled vehicle 1 is in the “acceleration/deceleration state” may be determined under the conditions same to those in the first embodiment. It is preferable, however, that the condition regarding the fourth time threshold is added due to the above reason.

When it is determined that the inverted two-wheeled vehicle 1 is in the “acceleration/deceleration state” (S21: Yes), the microcomputer 11 determines whether the place thus determined is registered in the list of places requiring attention as the place requiring attention (S22). The “list of places requiring attention” will be described later in detail. At this time, the position of the inverted two-wheeled vehicle 1 may be recognized as the position indicated by the positional information output from the indoor GPS receiver 17, as described above.

When it is determined that the place in which the inverted two-wheeled vehicle 1 is determined to be in the “acceleration/deceleration state” is registered as the place requiring attention (S22: Yes), an alerting indication is displayed on the display 5. This may be achieved by storing the image information indicating the alerting indication in the storage unit of the microcomputer 11 in advance, then acquiring, by the microcomputer 11, the image information which is to be displayed from the storage unit, and outputting the image information to the display 5.

When it is determined that the place in which the inverted two-wheeled vehicle 1 is determined to be in the “acceleration/deceleration state” is not registered as the place requiring attention (S22: No), the microcomputer 11 stores location information indicating the place at which the inverted two-wheeled vehicle 1 is accelerated or decelerated in the storage unit and stores frequency information indicating the number of times that the inverted two-wheeled vehicle 1 has visited the place in the storage unit (S24, S25). When the inverted two-wheeled vehicle 1 has visited the place before and the location information and the frequency information are stored in the storage unit, the microcomputer 11 updates the frequency information to count up the number of times that the inverted two-wheeled vehicle 1 has visited the place indicated by the frequency information.

The microcomputer 11 determines whether the number of times that the inverted two-wheeled vehicle 1 has visited the place indicated by the frequency information stored in the storage unit is larger than the visit frequency threshold (S26). When it is determined that the number of times that the inverted two-wheeled vehicle 1 has visited the place is larger than the visit frequency threshold (S26: Yes), the microcomputer 11 registers the place in the “list of places requiring attention” stored in the storage unit as the place requiring attention (S27).

According to the above configuration, it is possible to present the alerting indication to the rider as the processing in Step S23 stated above when the inverted two-wheeled vehicle 1 approaches the place requiring attention. It is therefore possible to improve attention of the rider and to achieve traveling with improved security. It is possible, for example, to start the operation for avoiding the contact of the rider with an obstacle at an earlier stage.

While the place is registered in the “list of places requiring attention” when the number of times that the inverted two-wheeled vehicle 1 has visited the place is larger than the visit threshold in the above description, the place may be registered in the “list of places requiring attention” when the inverted two-wheeled vehicle 1 is determined to be in the “acceleration/deceleration state” without taking into account the number of times that the inverted two-wheeled vehicle 1 has visited the place. Preferably, however, it is possible to suppress excessive registration in the list of places requiring attention by taking into account the number of times that the inverted two-wheeled vehicle 1 has visited the place as described above and to improve the accuracy for registering only the places to which the rider should really pay attention.

When the inverted two-wheeled vehicle 1 approaches the place registered in the list of places requiring attention, the alerting indication may be displayed at an earlier stage. Even when the inverted two-wheeled vehicle 1 is not determined to be in the “acceleration/deceleration state”, for example, the microcomputer 11 may compare the location registered in the list of places requiring attention with the current position of the inverted two-wheeled vehicle 1 at regular intervals and display the alerting indication when the distance between the location registered in the list of places requiring attention and the current position of the inverted two-wheeled vehicle 1 becomes shorter than a predetermined distance.

As long as the state of the emergency braking (deceleration state) can be determined, it is not necessary that the “acceleration/deceleration state” is determined and only the deceleration state except for the acceleration state may be determined. Specifically, the microcomputer 11 may display the alerting indication only when the pitch angle is negative even when the state in which the absolute value of the pitch angle is larger than the fourth angle threshold has ended in a period of time shorter than the fourth time threshold. In summary, as the state of the emergency braking (deceleration state), the “acceleration/deceleration state” may be determined as stated above and the strict “deceleration state” may be determined.

As described above, in the third embodiment, when it is determined that the traveling state of the inverted two-wheeled vehicle 1 (inverted vehicle) corresponds to the traveling state pattern of the deceleration state, the positional information indicating the current position is stored in the storage unit of the inverted two-wheeled vehicle 1 as the place requiring attention. When the inverted two-wheeled vehicle 1 approaches the position indicated by the positional information stored in the storage unit, the alerting indication is displayed on the display 5 (display unit). It is therefore possible for the rider to carry out avoidance behavior to prevent a contact of the inverted vehicle with an obstacle according to the alerting indication at an early stage, whereby the security level can further be improved.

Note that the present invention is not limited to the above embodiments and may be changed as appropriate without departing from the spirit of the present invention.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A display control method of a display unit for a rider provided in an inverted vehicle, the inverted vehicle controlling a traveling state according to a change in a posture of the rider, the posture being varied by the rider, wherein display control is carried out according to procedures including the following steps by a control apparatus included in the inverted vehicle:
a determination step of determining which of a plurality of traveling state patterns the traveling state according to the change in the posture of the inverted vehicle corresponds to, the plurality of traveling state patterns being defined in advance as the patterns that the inverted vehicle may take when the rider has a specific intention; and
a display step of displaying information according to the rider's intention corresponding to the traveling state pattern that is determined to correspond to the traveling state of the inverted vehicle on the display unit of the inverted vehicle.

2. The display control method according to claim 1, wherein:
the plurality of traveling state patterns comprise at least one of a traveling state pattern of a stop state and a traveling state pattern of an intermittent traveling state defined to be one state the inverted vehicle may take when the rider has an intention of looking at an interesting object, and
the display control method further comprises a position storing step of storing, when it is determined that the traveling state of the inverted vehicle corresponds to the traveling state pattern of the stop state or the intermittent traveling state, positional information indicating a current position in a storage unit of the inverted vehicle as a place in which the rider is interested.

3. The display control method according to claim 1, wherein:
the plurality of traveling state patterns comprise a traveling state pattern of a deceleration state, which is one state the inverted vehicle may take when the rider has an intention of avoiding something, and the display control method further comprises:
a position storing step of storing, when it is determined that the traveling state of the inverted vehicle corresponds to the traveling state pattern of the deceleration state, positional information indicating a current position in a storage unit of the inverted vehicle as a place requiring attention; and
an alerting step of displaying, when the inverted vehicle approaches the position indicated by the positional information stored in the storage unit, an alerting indication on the display unit.

4. The display control method according to claim 1, wherein:
the plurality of traveling state patterns comprise a traveling state pattern of the stationary traveling state and a traveling state pattern of the stop state, the stationary traveling state being defined to be one state the inverted vehicle may take when the rider has an intention of trying to move to a destination, the stop state being defined to be one state the inverted vehicle may take when the rider has an intention of trying to determine the destination, and
in the display step, map information is displayed as the information according to the rider's intention when it is determined that the traveling state of the inverted vehicle corresponds to the traveling state pattern of the stationary traveling state and information indicating a candidate of a destination is displayed as the information according to the rider's intention when it is determined that the traveling state of the inverted vehicle corresponds to the traveling state pattern of the stop state.

5. The display control method according to claim 1, wherein:
the inverted vehicle is used in a shopping mall including a plurality of shops,
the plurality of traveling state patterns comprise a traveling state pattern of a stationary traveling state and a traveling state pattern of a stop state, the stationary traveling state being defined to be one state the inverted vehicle may take when the rider has an intention of trying to move to a shop, the stop state being defined to be one state the inverted vehicle may take when the rider has an intention of trying to search for the shop, and
in the display step, map information is displayed as the information according to the rider's intention when it is determined that the traveling state of the inverted vehicle corresponds to the traveling state pattern of the stationary traveling state and shop information is displayed as the information according to the rider's intention when it is determined that the traveling state of the inverted vehicle corresponds to the traveling state pattern of the stop state.

6. The display control method according to claim 4, wherein:
the inverted vehicle controls the traveling state so that the inverted vehicle travels in a direction in which the posture of the inverted vehicle is inclined more than a predetermined reference posture and in a direction in which the posture of the inverted vehicle changes, and in the stationary traveling state, control to move the inverted vehicle in a direction opposite to the traveling direction according to the posture of the inverted vehicle which is inclined in the direction opposite to the traveling direction with respect to the reference posture in a state in which the posture of the inverted vehicle is inclined in the direction opposite to the traveling direction with respect to the reference posture and control to move the inverted vehicle in the traveling direction according to the change in the posture of the inverted vehicle to the traveling direction by the rider are cancelled with each other so that the inverted vehicle travels at a constant rate, and
in the determination step, it is determined that the traveling state of the inverted vehicle corresponds to the traveling state pattern of the traveling state when the inclination of the posture of the inverted vehicle with respect to the reference posture is larger than a first threshold, and it is determined that the traveling state of the inverted vehicle corresponds to the traveling state pattern of the stop state when the inclination of the posture of the inverted vehicle with respect to the reference posture is smaller than a second threshold which is equal to or smaller than the first threshold.

7. The display control method according to claim 6, wherein:
the plurality of traveling state patterns further comprise a traveling state pattern of an acceleration/deceleration state and a traveling state pattern of an intermittent traveling state, the acceleration/deceleration state being defined to be one state the inverted vehicle may take when the rider has an intention of trying to move to a shop, the intermittent traveling state being defined to be one state the inverted vehicle may take when the rider has an intention of trying to select an item to purchase at the shop, and
in the display step, map information is further displayed as information according to the rider's intention when it is determined that the traveling state of the inverted vehicle corresponds to the traveling state pattern of the acceleration/deceleration state, and advertising information of the shop is further displayed as information according to the rider's intention when it is determined that the traveling state of the inverted vehicle corresponds to the traveling state pattern of the intermittent traveling state.
